(19) United States
(12) Patent Application Publication
(10) Pub. No.: US 2010/0134811 A1
(43) Pub. Date: Jun. 3, 2010

(54) PRINTING CONTROL DEVICE AND PRINTING CONTROL SYSTEM HAVING THE PRINTING CONTROL DEVICE

(75) Inventors: Kenji Fukasawa, Suwa-shi (JP); Yoshifumi Arai, Suwa-shi (JP); Hidekuni Moriya, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/623,261

(22) Filed: Nov. 20, 2009

(30) Foreign Application Priority Data
Nov. 28, 2008 (JP) 2008-303513

(51) Int. Cl. H04N 1/50

(52) U.S. Cl. 358/1.9

(57) ABSTRACT

A printing control device includes a texture control unit that acquires texture control data, which is used for controlling the texture of a printing surface of a printing material printed by a printing apparatus, based on texture information data that represents the texture of the printing surface of the printing material.

### BACKGROUND

1. Technical Field

The present invention relates to a technology for controlling the texture of a printing surface of a printing material that is printed by a printing apparatus.

2. Related Art

In a general color management process, the transfer of color information or match of color information between different color reproducing devices is implemented by using a characteristic descriptive file referred to as a profile that describes the color reproducing characteristics of each color reproducing device based on the ICC (International Color Consortium) standards and a color converting engine that converts the color information between different types of devices by using the information of the characteristic descriptive file. However, by using the above-described color management technology, only the color information can be handled, and the surface texture information such as gloss, metal gloss, roughness, or concavity and convexity cannot be handled.

In addition, in a case where a printing material having a metallic or embossing processing, wrinkles, or the like is generated as a highly value-added printing material, a time consuming operation requiring much labor such as designation of the color and the texture by using a sample patch or repetition of performing corrected printing in the presence of an ordering party many times in a correction process performed by a printing apparatus for finishing the final printing material has been performed. In addition, a highly value-added printing material can be generated only by using a method depending on a worker's sense.

Meanwhile, in the field of computer graphics, a technology for reproducing the realistic texture of the surface of an object on a display screen as a computer graphics image has been developed. In particular, 3D-CG generation software using an open source such as OpenGL or DirectX has been developed. Thus, by using such software, a realistic image that may be taken for a real photograph can be generated in consideration of both direct light and indirect light by artificially generating various texture attributes of the surface of an object such as gloss, concavity and convexity, transparency, and roughness. Therefore, generally, such software has been widely used in an SF movie, game software, or the like. Moreover, recently, software that enables a user to check the design of a product, the coating state of the surface of a product, or the like on the screen of a display has been developed and shipped to the market. Thus, by using such software, generation of a mock-up can be suppressed to be the minimum in the development of the design of a car, clothes, or a general product or the like, and accordingly, the efficiency of the product development is increased.

As described above, in the field of commercial printing, printing apparatuses that print an actual image have various surface processing functions so as to generate a highly value-added printing material. However, design software for generating an edition of a printing material or a digital image data or color management software that is embedded in the operating system does not respond to the management or information delivery of the surface texture of such a printing material, and a technology for responding thereto has not been set up.

As approaches to the representation of the texture of the surface of the object, for example, a technology described in “Generalization of Lambert's Reflectance Model” Michael Oren and Shree K. Nayar; Department of Computer Science, Columbia University: New York, N.Y. 10027 and “A Reflectance Model for Computer Graphics” ROBERT L. COOK (Lucasfilm Ltd.) and KENNETH E. TORRANCE (Cornell University); ACM Transactions on Graphics, Vol. 1, No. 1, January 1982 have been known.

However, generally, a method of controlling the texture of the printing surface of a printing material that is printed by a printing apparatus has not been considered.

### SUMMARY

An advantage of some aspects of the invention is that it provides technology for controlling the texture of the printing surface of a printing material that is printed by a printing apparatus.

The invention may be implemented in the following forms or applications.

### Application 1

According to Application 1, there is provided a printing control device including: a texture control unit that acquires texture control data, which is used for controlling the texture of a printing surface of a printing material printed by a printing apparatus, based on texture information data that represents the texture of the printing surface of the printing material.

According to the above-described printing control device of Application 1, the texture control data is acquired based on the texture information data that represents the texture of the printing surface of a printing material. Accordingly, when the acquired texture control data is used by the printing apparatus, the texture of the printing surface of the printing material printed by the printing apparatus can be controlled. Therefore, by user's supplying desired texture as the texture information data, a highly value-added printing material having the texture that is desired by the user can be acquired.

### Application 2

In the printing control device according to Application 1, the texture information data includes at least one of gloss data used for representing the gloss, metallic degree data used for representing metallic gloss, and a surface height used for representing concavity and convexity.

Since the above-described data is included as the texture information data, the texture desired by the user can be represented specifically.

### Application 3

In the printing control device according to Application 1 or 2, in a case where the printing apparatus includes at least one of clear ink, metallic ink, and UV-curable ink, the texture control data includes data that represents the amount of the corresponding ink used for printing.

Since the texture control data includes the above-described data, the amount of the ink, which relates to the texture, used for printing by the printing apparatus can be controlled. Accordingly, the texture of the printing surface of a printing material that is printed by the printing apparatus can be controlled.

### Application 4

In the printing control device according to Application 1, the texture control unit includes a lookup table that represents the correspondence relationship between the value of the texture information data and the value of the texture control data.

By using the above-described lookup table, the texture control data can be acquired in an easy manner based on the texture information data.

### Application 5

The above-described printing control device according to any one of Applications 1 to 4 further includes a print data deriving unit that derives print data used for performing image printing based on the image data, and the texture information data is data that is associated with the image data.

By including the print data deriving unit as described above, not only the texture control data but also the print data can be derived. In addition, in a case where the texture control data together with the derived print data is used by the printing apparatus, the texture of the printing surface for the image can be controlled when image printing is performed by using the printing apparatus.

### Application 6

According to Application 6, there is provided a printing control system including: the above-described printing control device according to any one of Applications 1 to 5; and a printing apparatus that performs printing while controlling the texture of the printing surface of the printing material based on the texture control data that is acquired by the texture control unit.

By using the above-described system, a highly value-added printing material having the texture that is desired by a user can be acquired.

### Application 7

According to Application 7, there is provided a method of acquiring texture control data. The method includes: acquiring texture control data, which is used for controlling the texture of a printing surface of a printing material printed by a printing apparatus, based on texture information data that represents the texture of the printing surface of the printing material.

According to the above-described method of Application 7, the same advantages as those of Application 1 can be acquired.

### Application 8

According to Application 8, there is provided a computer program that is used for acquiring texture control data. The computer program allows a computer to have a function of: acquiring texture control data, which is used for controlling the texture of a printing surface of a printing material printed by a printing apparatus, based on texture information data that represents the texture of the printing surface of the printing material.

According to the above-described computer program of Application 8, the same advantages as those of Application 1 can be acquired.

Furthermore, the invention is not limited to the form of a device such as the printing control device or the printing control system described above, the form of a method such as the method of acquiring the texture control data, or the form of a computer program used for implementing the method or device described above. Thus, the invention can be implemented in various forms such as the form of a recording medium having such a computer program recorded thereon or a data signal that is implemented in a carrier wave including the above-described computer program.

### BRIEF DESCRIPTION OF THE DRAWINGS

The invention will be described with reference to the accompanying drawings, wherein like numbers reference like elements.

FIG. 1 is a block diagram showing a printing control system according to an embodiment of the invention.

FIG. 2 is an explanatory diagram showing an example of image data and texture information data that are stored in a hard disk device.

FIG. 3 is a schematic block diagram showing the data processing procedure of the printing control system shown in FIG. 1.

FIG. 4 is a graph showing the correspondence relationship between the gloss of the printing surface of a printing material and the amount of clear ink used in the printing process.

FIG. 5 is a graph showing the correspondence relationship between the metallic degree of the printing surface of a printing material and the amount of the metallic ink used in the printing process.

FIG. 6 is an explanatory diagram showing macro-appearance as a measurement method for calculating the metallic degree.

FIG. 7 is a graph showing the correspondence relationship between the surface height of the printing surface of a printing material and the amount of UV-curable ink used in the printing process.

FIG. 8 is a schematic block diagram representing the data processing procedure in a printing control system according to a modified example of the invention.

### DESCRIPTION OF EXEMPLARY EMBODIMENTS

### Configuration of Embodiment

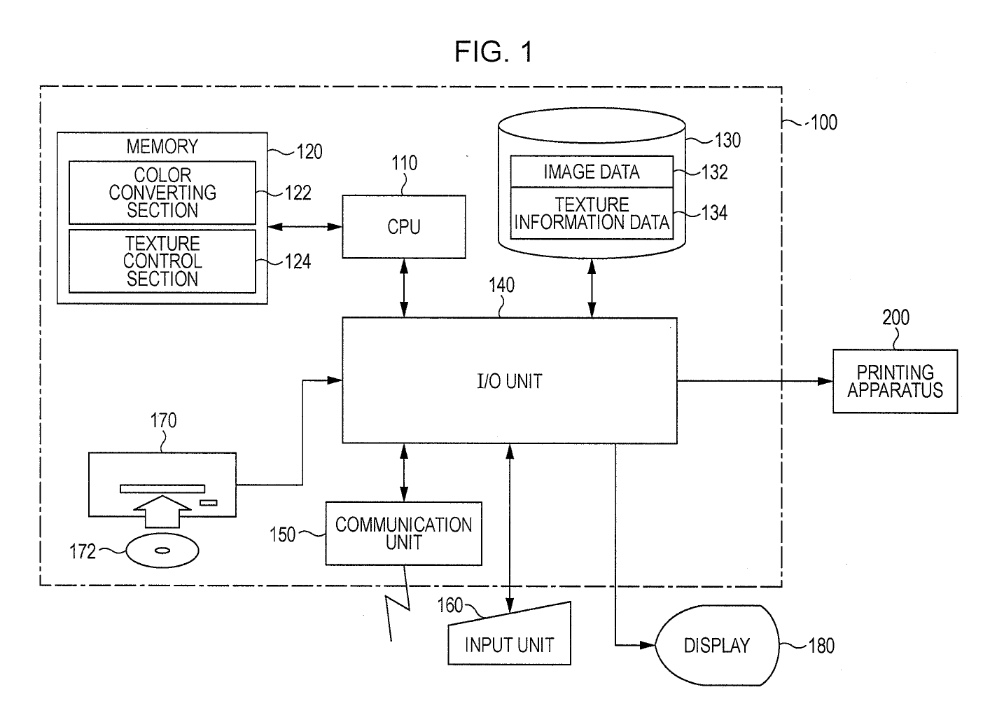

FIG. 1 is a block diagram showing a printing control system according to an embodiment of the invention. The printing control system shown in FIG. 1 is configured by a personal computer (hereinafter, simply referred to as a PC) 100 that is a printing control device and a printing apparatus 200 that performs a printing operation of an image.

Among these components, the PC 100, as shown in FIG. 1, includes a CPU 110 that performs various processes and control operations by executing computer programs such as applications, a memory 120 that is used for storing the above-described computer programs or temporarily storing data or information acquired in the middle of the processes therein, a hard disk device 130 that is used for storing image data 132 and the like therein, an I/O unit 140 that is used for exchanging data or information between the CPU 110 and various peripheral devices, a communication unit 150 that is formed of a network card or the like and is used for performing communication with other devices through a network, an input unit 160 that is formed of a keyboard, a pointing device, or the like and is used for a user to input a direction, an information reading unit 170 that is used for reading out information from a recording medium 172 such as a CD-ROM in which the above-described computer programs and the like are written, and a display 180 that is used for displaying an image.

The CPU 110 serves as a color converting section 122 and a texture control section 124 by executing computer programs that are stored in the memory 120.

As described above, in this embodiment, a case where a CD-ROM or the like is used as a “recording medium” that stores computer programs therein so as to be readable by a computer has been described. However, as the “recording medium”, various types of a computer-readable media such as a flexible disk or an optical magnetic disk, an IC card, a ROM cartridge, a punch card, a print material in which a code such as a bar code is printed, or an internal memory device (a memory such as a RAM or a ROM) of a computer and an external memory device may be used. The computer program may be configured to be acquired by the PC from a program server by accessing the program server (not shown) that supplies computer programs through a network, instead of being provided in a form recorded in such a recording medium. In addition, some of the above-described computer programs may be configured by the operating system program.

In addition, the printing apparatus 200 has clear ink that is used for representing gloss on the printing surface, metallic ink that is used for representing metallic gloss (metallic feeling), and ultraviolet (UV) curable ink that is used for representing roughness or concavity and convexity, in addition to inks of cyan, magenta, yellow and black for performing color printing.

In the hard disk device 130 of the PC 100, image data 132 that represents a color image is stored. In this embodiment, for example, R, G, and B that is image data of the RGB display color system is used as the image data 132. In addition, L*, a*, and b* that is image data of the L*a*b display color system other than the image data R, G, and B may be configured to be used. In addition, in the hard disk device 130, texture information data 134 that is associated with the image data 132 is stored together with the above-described image data 132. In this embodiment, for example, the texture information data 134 is configured by gloss data GL for representing the gloss, metallic degree data MT for representing the metallic gloss, and surface height data h for representing the concavity and convexity, in association with the color image represented by the image data 132.

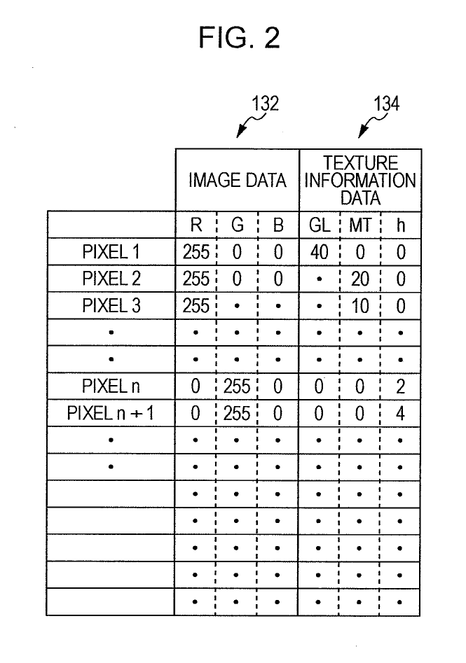

FIG. 2 is an explanatory diagram showing an example of the image data 132 and the texture information data 134 that are stored in the hard disk device 130. As shown in FIG. 2, values of the image data 132 and the texture information data 134 are stored for each pixel.

In this embodiment, the PC 100 corresponds to a printing control device according to an embodiment of the invention, and the color converting section 122 of the PC 100 corresponds to a print data deriving unit according to an embodiment of the invention.

### Operation of Embodiment

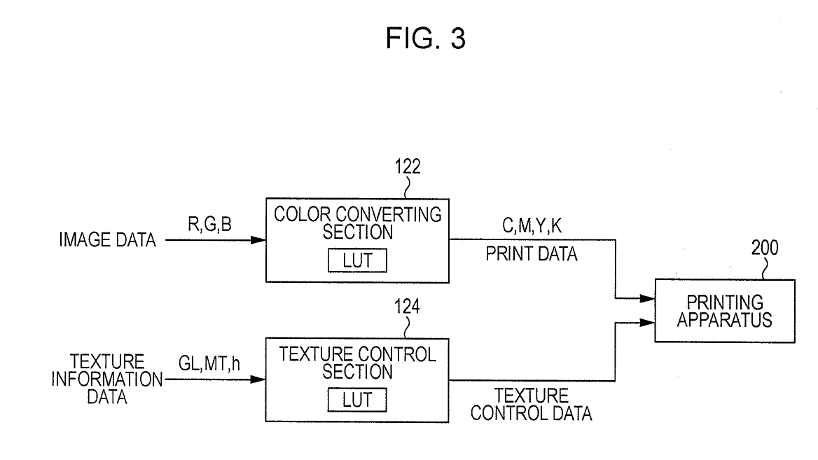

Hereinafter, the operation of this embodiment will be described with reference to FIGS. 1 and 3. FIG. 3 is a schematic block diagram showing the data processing procedure of the printing control system shown in FIG. 1.

When a user directs to print an image by designating image data 132 that is stored in the hard disk device 130 by operating the input unit 160, first, the image converting section 122 functioned by the CPU 110 reads out the image data 132 from the hard disk device 130, and the texture control section 124 reads out the texture information data 134 that is associated with the image data 132.

Then, the color converting section 122 of the above-described sections converts the read-out image data 132 into print data that is used for color printing by the printing apparatus 200. In other words, the color converting section 122 converts the image data R, G, and B into the print data C, M, Y, and K that represents the amount of ink used in a printing process for each of the cyan, magenta, yellow and black inks that are included in the printing apparatus 200. In particular, the color converting section 122 converts the image data in colors into the print data so as to be adapted to the range of color reproduction of the printing apparatus 200 by using a lookup table (LUT). The print data C, M, Y, and K acquired as described above is output to the printing apparatus 200.

Meanwhile, the texture control section 124 converts the read-out texture information data 134 into texture control data that is used for controlling the texture of the printing surface of a printing material printed by the printing apparatus 200. Such conversion from the texture information data into the texture control data, similarly to the color conversion, is performed by using the lookup table. The texture control data acquired as described above is output to the printing apparatus 200, similarly to the print data.

The conversion from the texture information data into the texture control data will now be described further in detail. The texture control section 124 converts the gloss data GL included in the read-out texture information data 134 into data that represents the amount of the clear ink, which is included in the printing apparatus 200, used in a printing process, converts the metallic degree data MT into data that represents the amount of the metallic ink, which is included in the printing apparatus 200, used in a printing process, and converts the surface height data h into data that represents the amount of the UV-curable ink, which is included in the printing apparatus 200, used in a printing process.

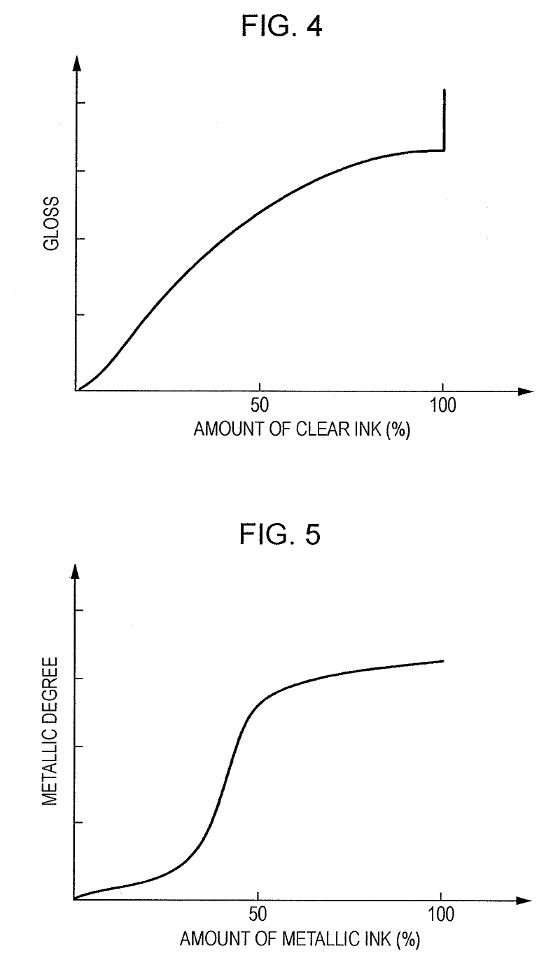

FIG. 4 is a graph showing the correspondence relationship between the gloss of the printing surface of a printing material and the amount of the clear ink used in the printing process. In FIG. 4, the vertical axis represents the gloss, and the horizontal axis represents the amount of the clear ink. The amount of the clear ink is represented by the ratio [%] of the number of dots printed with the clear ink to the total number of dots in the unit area of the printing surface.

The correspondence relationship between the gloss and the amount of the clear ink shown in FIG. 4 can be calculated as follows. First, a chart in which a plurality of patches formed by using different amounts of ink that is the same as the clear ink used by the printing apparatus 200 is printed. Then, the specular gloss of each patch in the chart is measured for the surface of the patch in conformity with JIS Z 8741 (specular gloss measuring method), and the measurement result is acquired as the gloss. Then, the correspondence relationship between the gloss and the amount of the clear ink as shown in FIG. 4 is derived for each patch based on the correspondence relationship between the amount of the clear ink used in the printing process and the gloss acquired by the measurement. In the case of the clear ink, it is preferable that “number 20 specular gloss”, in which the gloss is measured with both the incidence angle of a light source and the light receiving angle for the light receiving portion configured as 20°, out of measurement methods conforming with the JIS Z 8741 is used.

FIG. 5 is a graph showing the correspondence relationship between the metallic degree of the printing surface of a printing material and the amount of the metallic ink used in the printing process. In FIG. 5, the vertical axis represents the metallic degree, and the horizontal axis represents the amount of the metallic ink. Similarly to the case of the clear ink, the amount of the metallic ink is represented by the ratio [%] of the number of dots printed with the metallic ink to the total number of dots in the unit area of the printing surface.

The correspondence relationship between the metallic degree and the amount of the metallic ink shown in FIG. 5, similarly to the case of the clear ink, can be acquired by using a chart. First, a chart is printed by using ink that is the same as the metallic ink used by the printing apparatus 200. Then, measurement is performed for the surface of each patch in the chart by using macro-appearance, and the metallic degree is calculated based on the measurement result. Then, the correspondence relationship between the metallic degree and the amount of the metallic ink as shown in FIG. 5 is derived for each patch based on the correspondence relationship between the amount of the metallic ink used in the printing process and the metallic degree acquired based on the measurement result.

Here, the macro-appearance is a method of measuring the metallic degree by measuring the reflected light at variable angles by using the fact that the brightness or the sharpness of a measurement target is changed in accordance with the observation angle.

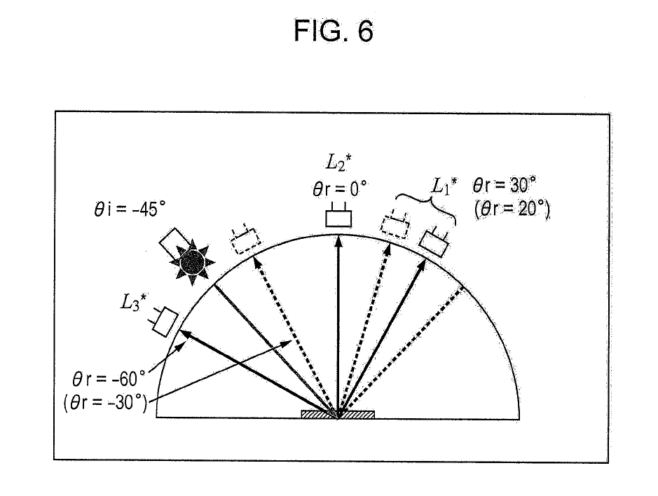

FIG. 6 is an explanatory diagram showing the macro-appearance as a measurement method for calculating the metallic degree. As shown in FIG. 6, in the macro-appearance, light is emitted to a measurement target at the angle θi=−45°, the light reflected from the measurement target is received at several angles of θr=30° (or θr=20°), θr=0°, and θr=−60° (or θr=−30°), and the brightness L*₁, L*₂, and L*₃ at the position is measured. Then, the metallic degree F. is derived by substituting the measurement result in the following Equation (1).

$$\begin{matrix}Equation ( 1 ) & \\ F = \frac{2.69 {( {L}_{1}^{*} - {L}_{3}^{*} )}^{1.11}}{{L}_{2}^{* 0.86}} & ( 1 )\end{matrix}$$

Here, the metallic degree S shown in Equation (2) may be used as an approximate value.

$$\begin{matrix}Equation ( 2 ) & \\ S = \frac{3 ( {L}_{1}^{*} - {L}_{3}^{*} )}{{L}_{2}^{*}} & ( 2 )\end{matrix}$$

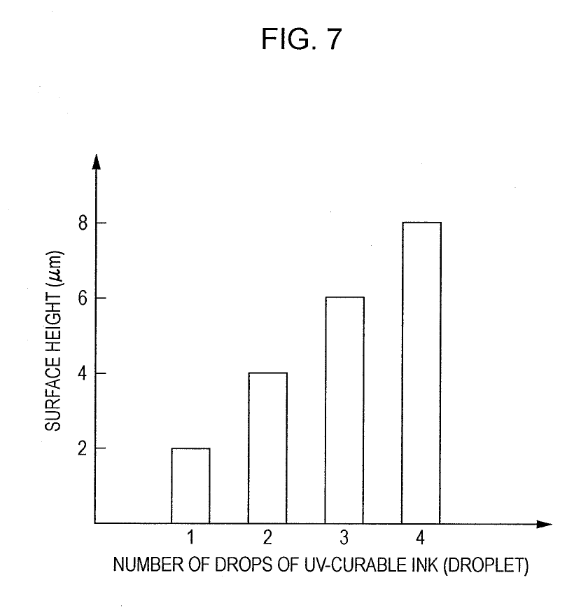

FIG. 7 is a graph showing the correspondence relationship between the surface height of the printing surface of a printing material and the amount of the UV-curable ink used in the printing process. In FIG. 7, the vertical axis represents the surface height, and the horizontal axis represents the number of drops of the UV-curable ink.

The correspondence relationship between the surface height and the number of drops of the UV-curable ink, which is shown in FIG. 7, can be acquired as follows. First, a printing process is performed for a printing medium by using ink that is the same as the UV-curable ink used by the printing apparatus 200, and the ink is cured by irradiating ultraviolet rays, whereby a chart, in which a plurality of patches formed by different numbers of drops is arranged, is printed. By measuring a height from the surface of the printing medium to the top for each patch in the chart, the surface height [μm] is acquired. Then, the correspondence relationship as shown in FIG. 7 is derived based on the correspondence relationship between the number of drops [droplets] of the UV-curable ink and the surface height [μm] acquired by the measurement for each patch.

Then, based on the correspondence relationships represented in FIGS. 4, 5, and 7 acquired as described above, a lookup table that is used by the texture control section 124 shown in FIG. 3 is generated. In other words, a lookup table that receives the gloss, the metallic degree, and the surface height as inputs, and outputs the amount of the clear ink, the amount of the metallic ink, and the number of drops of the UV-curable ink is generated. At this moment, for example, as shown in FIG. 4, when the value of the gloss is too high to be represented even by using 100% amount of the clear ink, the data value of the lookup table is adjusted so as to output 100% amount of the clear ink for all the high values of the gloss.

All the print data C, M, Y, and K and the texture control data that are acquired as above are input to the printing apparatus 200 as described above. The printing apparatus 200 performs printing of a color image on a printing sheet (not shown) by using the cyan, magenta, yellow and black inks based on the print data C, M, Y, and K. In addition, the printing apparatus 200 simultaneously performs printing so as to represent the texture such as the gloss, the metallic feeling, the roughness, or the concavity and convexity on the printing surface of the same printing sheet based on the texture control data by using the clear ink, the metallic ink, and the UV-curable ink. As a result, a highly value-added printing material having desired texture on the printing surface thereof can be acquired.

As described above, according to this embodiment, the texture information data 134 that is associated with the image data 132 is converted into the texture control data that includes data representing the amounts of the clear ink, the metallic ink, and the UV-curable ink used in the printing process, and the converted texture control data is input to the printing apparatus 200. Then, the printing apparatus 200 performs printing by using the clear ink, the metallic ink, and the UV-curable ink based on the texture control data. Accordingly, by preparing desired texture information data, the texture of the printing surface of a printing material that is printed by the printing apparatus 200 can be controlled to be the texture that is intended by a user.

### MODIFIED EXAMPLES

The invention is not limited to the above-described embodiment or example and may be performed in various forms within the scope not departing from the basic idea thereof.

### Modified Example 1

According to the above-described embodiment, the PC 100 serving as a printing control device acquires the print data and the texture control data and inputs the acquired data to the printing apparatus 200, and the printing apparatus 200 performs printing for representing the texture on a printing surface based on the texture control data together with performing printing of a color image based on the print data. However, the invention is not limited thereto. For example, in a case where there is a printing material for which color image printing has been performed, printing may be performed so as to represent the desired texture on the printing surface of the printing material. In such a case, the PC 100 serving as the printing control device only needs to acquire the texture control data, and accordingly, the PC 100 does not need the color converting section 122 and needs to include at least the texture control section 124. In addition, as the function of the printing apparatus 200, the function of printing a color image is not necessarily needed, and a function of printing for representing the texture on the printing surface based on the texture control data, that is, a function of printing by using the clear ink, the metallic ink, the UV-curable ink and the like may be included.

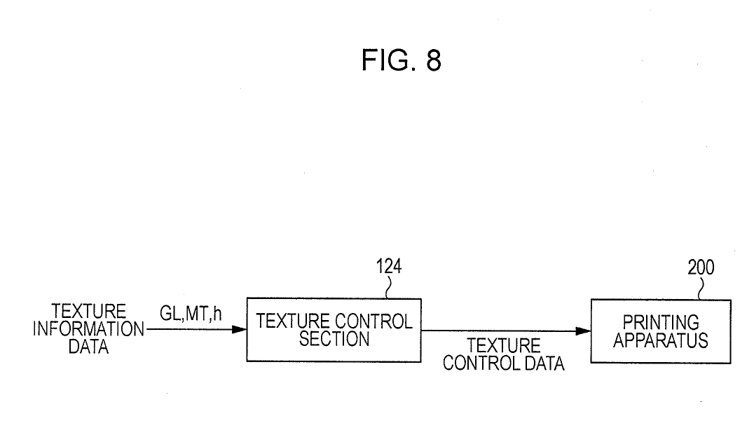

FIG. 8 is a schematic block diagram representing the data processing procedure in such a printing control system. In the system shown in FIG. 8, the color converting section 122 is not included, and only the texture control section 124 is configured to convert the texture information data 134 into texture control data and output the texture control data to the printing apparatus 200.

### Modified Example 2

According to the above-described embodiment, the print data is derived from the image data 132 by the color converting section 122, and the texture control data is acquired from the texture information data 134 by the texture control section 124. However, it may be configured that the color converting section 122 and the texture control section 124 are integrated together, and both the print data and the texture control data are derived from both the image data 132 and the texture information data 134. For example, such a configuration may be implemented by allowing a functional section, which is configured by integrating the color converting section 122 and the texture control section 124, to include a lookup table that receives the values of the image data 132 and the texture information data 134 as input and outputs the values of the print data and the texture control data. In such a case, the information included in the image data can be reflected on the texture control data, and the information included in the texture information data can be reflected on the print data. In addition, as an example modified further, a lookup table that receives the values of the image data and the texture information data as input and outputs the value of the texture control data may be configured to be used, or a lookup table that receives the values of the image data and the texture information data as input and outputs the value of the print data may configured to be used.

### Modified Example 3

In the above-described embodiment, the texture information data is configured by the gloss data GL, the metallic degree data MT, and the surface height data h. However, the invention is not limited thereto. Thus, the texture information data may include at least one of the gloss data GL, the metallic degree data MT, and the surface height data h.

In addition, the texture information data may be configured to be represented by using parameters of a bidirectional reflectance distribution function (BRDF) instead of the above-described data. Here, the “BRDF” is a physical amount that is acquired by describing the relationship between the incident light and the reflected light in all the directions of a half celestial sphere for an arbitrary observation point on the target surface of an object. Since the “optical BRDF” that is the BRDF measured based on the spectroscopic characteristics can describe the color of an object and the characteristics of the reflection thereof, the “optical BRDF” has already been widely used for artificially generating a realistic image in the computer graphics field.

### Modified Example 4

In the above-described embodiment, the printing apparatus 200 is configured to use ink as a print recording material. However, the printing apparatus 200 may be configured to use a different recording material such as toner.

### Modified Example 5

In the above-described embodiment, the acquired texture control data is used by the printing apparatus 200. However, the invention is not limited thereto. Thus, the texture control data may be configured to be directly stored, transferred, or processed or may be used for evaluating the texture.

This application claims priority to Japanese Patent Application No. 2008-303513, filed Nov. 28, 2008, the entirety of which is incorporated by reference herein.

What is claimed is:

1. A printing control device comprising: a texture control unit that acquires texture control data, which is used for controlling the texture of a printing surface of a printing material printed by a printing apparatus, based on texture information data that represents the texture of the printing surface of the printing material.

2. The printing control device according to claim 1, wherein the texture information data includes at least one of gloss data used for representing the gloss, metallic degree data used for representing metallic gloss, and a surface height used for representing concavity and convexity.

3. The printing control device according to claim 1, wherein, in a case where the printing apparatus includes at least one of clear ink, metallic ink, and UV-curable ink, the texture control data includes data that represents the amount of the corresponding ink used for printing.

4. The printing control device according to claim 1, wherein the texture control unit includes a lookup table that represents the correspondence relationship between the value of the texture information data and the value of the texture control data.

5. The printing control device according to claim 1, further comprising a print data deriving unit that derives print data used for performing image printing based on the image data,
wherein the texture information data is data that is associated with the image data.

6. A printing control system comprising:
the printing control device according to claim 1; and
a printing apparatus that performs printing while controlling the texture of the printing surface of the printing material based on the texture control data that is acquired by the texture control unit.

7. A method of acquiring texture control data, the method comprising: acquiring texture control data, which is used for controlling the texture of a printing surface of a printing material printed by a printing apparatus, based on texture information data that represents the texture of the printing surface of the printing material.

8. A computer program product that is used for acquiring texture control data, the computer program product allows a computer to have a function of: acquiring texture control data, which is used for controlling the texture of a printing surface of a printing material printed by a printing apparatus, based on texture information data that represents the texture of the printing surface of the printing material.
